(19) United States
(12) Patent Application Publication
(10) Pub. No.: US 2006/0139307 A1
(43) Pub. Date: Jun. 29, 2006

(54) Electrophoretic display panel

(75) Inventors: Guofu Zhou, Eindhoven (NL); Mark Thomas Johnson, Eindhoven (NL); Neculai Ailenei, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/545,062

(22) PCT Filed: Jan. 29, 2004
(86) PCT No.: PCT/IB04/50063

§ 371 Date: Aug. 10, 2005

(30) Foreign Application Priority Data
Feb. 13, 2003 (EP) 03100316.3

(51) Int. Cl. G09G 3/34

(52) U.S. Cl. 345/107

(57) ABSTRACT

The electrophoretic display panel (1), for displaying a picture, has drive means (100) which are arranged for controlling the potential difference of each picture element (2) to be a sequence of preset potential differences and subsequently to be a picture potential difference for enabling the particles (6) to occupy one of said positions for displaying the picture. Each preset potential difference represents a preset energy and has as a result a change of the position of the particles (6). For the display panel (1) to be able to display a picture of relatively high quality and to have relatively small changes in the appearances of picture elements (2) as a result of the sequences of preset potential differences even when the number of preset potential differences in the sequences is relatively small, the drive mean (100) are further arranged for controlling for each picture element (2) of at least a number of the picture elements (2) the preset energies of the preset potential differences in the sequence to depend on a serial number in the sequence to obtain for each preset potential difference in the sequence a substantially equal magnitude of the change of the position of the particles (6).

The invention relates to an electrophoretic display panel, for displaying a picture, comprising:
an electrophoretic medium comprising charged particles in a fluid;
a plurality of picture elements;
a first and a second electrode associated with each picture element for receiving a potential difference; and
drive means,
   the charged particles being able to occupy extreme positions near the electrodes and intermediate positions in between the electrodes,
   the drive means being arranged for controlling the potential difference of each picture element
to be a sequence of preset potential differences having preset values and associated preset durations, the preset values in the sequence alternating in sign, each preset potential difference representing a preset energy sufficient to release particles present in one of said extreme positions from their position but insufficient to enable said particles to reach the other one of the extreme positions, each preset potential difference having as a result a change of the position of the particles, and subsequently
to be a picture potential difference for enabling the particles to occupy one of said positions for displaying the picture.

An embodiment of the electrophoretic display panel of the type mentioned in the opening paragraph is described in non-prepublished European Patent application 02077017.8 (PHNL020441).

In electrophoretic display panels in general, the picture elements have, during the display of the picture, appearances determined by the positions of the charged particles between the electrodes. The positions of the particles depend, however, not only on the potential differences, but also on the history of the potential differences. As a result the picture being displayed according to image information differs significantly from a picture being an exact representation of the image information. Therefore, the picture being displayed has a relatively low picture quality. The dependency on the history is reduced in the described electrophoretic display panel by the application of the sequence of preset potential differences, each preset potential difference having substantially the same preset energy, before the application of the picture potential differences. The total energy represented by the sequence of preset potential differences determines the reduction in dependency on the history. As a result, the picture quality in the described electrophoretic display panel can be relatively high. However, each preset potential difference results in a change of the position of the particles.

The change of the position is defined by a change in distance between the particles and one of the electrodes. Therefore, each preset potential difference results in a change of appearance of the picture element. This change in appearance of the picture element, which is relatively large for a relatively large magnitude of the change of the position of the particles, is visible in the appearance of the display panel. The dependency on the magnitudes of the changes of appearance as a result of the sequence of preset potential differences is an increasing function of the preset energy. Therefore, the visibility could be reduced by a decrease of the preset energy. However, this would cause a decrease of the picture quality because of the decrease of the total energy in the sequence. The visibility could be reduced without a decrease of the picture quality by a decrease of the preset energy and an increase of the number of preset potential differences in the sequence for a constant value of the total energy in the sequence. This, however, results in a relatively long sequence and therefore a relatively slow picture update.

It is a drawback of the described display panel that it is difficult to obtain therewith a relatively high picture quality and relatively small changes in the appearances of picture elements as a result of the sequences of preset potential differences when the number of preset potential differences in the sequences is relatively small.

It is an object of the invention to provide a display panel of the kind mentioned in the opening paragraph which is able to display a picture of relatively high quality and to have relatively small changes in the appearances of picture elements as a result of the sequences of preset potential differences, even when the number of preset potential differences in the sequences is relatively small.

The object is thereby achieved that the drive means are further arranged for controlling for each picture element of at least a number of the picture elements the preset 5 energies of the preset potential differences in the sequence to depend on a serial number in the sequence to obtain for each preset potential difference in the sequence a substantially equal magnitude of the change of the position of the particles.

It has been observed that in the display panel of the said patent application, in which each preset potential difference has substantially the same preset energy, the magnitude of the change of the position of the particles as a result of a preset potential difference is an increasing function of its serial number in the sequence. An explanation might be as follows. Prior to the application of the sequence of preset potential differences, the particles are relatively immobile due to the viscosity of the fluid. Each subsequent preset potential difference in the sequence results in an increase in mobility of the particles. Therefore, the magnitude of the change of the position of the particles of each subsequent preset potential difference in the sequence increases resulting in an increasing change in appearance of the picture element due to each subsequent preset potential difference in the sequence. For each picture element of the number, the preset potential differences in the sequence of the display panel according to the invention have preset energies which depend on the serial number in the sequence to obtain for each preset potential difference in the sequence a substantially equal magnitude of the change of the position of the particles. As a result, for each picture element of the number the largest magnitude of the change of the position of the particles is smaller than the largest magnitude of the change of the position of the particles in the display panel of the said patent application, for the same total energy, which results in relatively small changes in the appearance.

In an embodiment the drive means are further arranged for controlling for each picture element of at least the number of the picture elements the preset energies of the preset potential differences in the sequence to be a decreasing function of the serial number. It is furthermore favorable, if the function is substantially linear. The driving scheme can relatively simply be implemented in the drive means, then.

For each picture element of the number the preset energies in the sequence may be controlled by controlling both the preset values and the preset durations.

If the drive means are further arranged for controlling for each picture element of at least the number of the picture elements the preset values of the preset potential differences in the sequence to control the preset energies in the sequence, the preset durations in the sequence may be substantially constant.

Alternatively, if the drive means are further arranged for controlling for each picture element of at least the number of the picture elements the preset durations of the preset potential differences in the sequence to control the preset energies in the sequence, relatively simple drive electronics may be used with substantially constant absolute values of the preset values of the preset potential differences in the sequence.

If the drive means are further arranged for controlling for each picture element of at least the number of the picture elements the sequence to have an even number of preset potential differences and

the preset energy of each preset potential difference having an even serial number to be substantially equal to the preset energy of the respective preceding preset potential difference, the DC component of the sequences of preset potential differences is decreased.

It is favorable, if, in each aforementioned embodiment, each picture element is one of the number of the picture elements.

These and other aspects of the display panel of the invention will be further elucidated and described with reference to the drawings, in which:

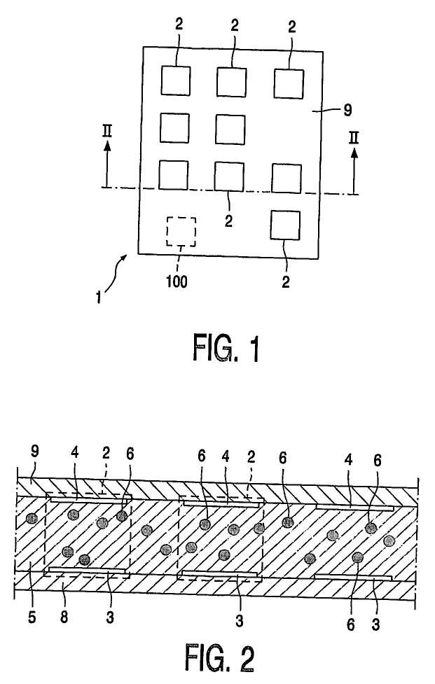

FIG. 1 shows diagrammatically a front view of an embodiment of the display panel;

FIG. 2 shows diagrammatically a cross-sectional view along II-II in FIG. 1;

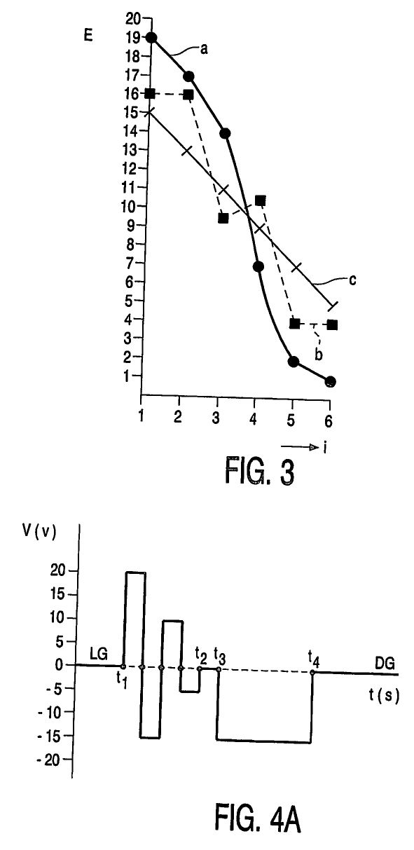

FIG. 3 shows in a graphical form three examples of the relation between the serial number i in the sequence and the preset energy E of the preset potential differences in the sequence;

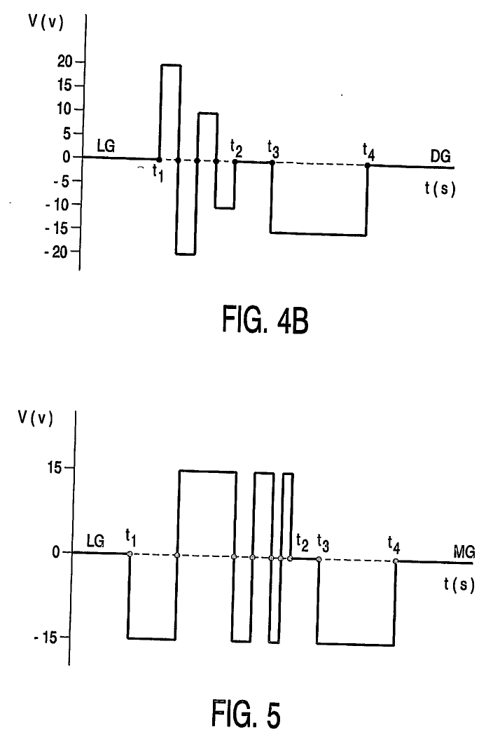

FIG. 4A shows diagrammatically the potential difference as a function of time for a picture element of the number of picture elements in the embodiment;

FIG. 4B shows diagrammatically the potential difference as a function of time for another picture element of the number of picture elements in the embodiment, and

FIG. 5 shows diagrammatically the potential difference as a function of time for a picture element of the number of picture elements in another embodiment.

In all the Figures corresponding parts are referenced to by the same reference numerals.

FIGS. 1 and 2 show the embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6 in a fluid, is present between the substrates 8,9. A first and a second electrode 3,4 are associated with each picture element 2 for receiving a potential difference. In FIG. 2 the first substrate 8 has for each picture element 2 a first electrode 3, and the second substrate 9 has for each picture element 2 a second electrode 4. The charged particles 6 are able to occupy extreme positions near the electrodes 3,4 and intermediate positions in between the electrodes 3,4. Each picture element 2 has an appearance determined by the position of the charged particles 6 between the electrodes 3,4. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are arranged for controlling the potential difference of each picture element 2 to be a sequence of preset potential differences having preset values and associated preset durations, the preset values in the sequence alternating in sign.

Furthermore, each preset potential difference represents a preset energy sufficient to release particles 6 present in one of said extreme positions from their position but insufficient to enable said particles 6 to reach the other one of the extreme positions. Each preset potential difference has as a result a change of the position of the particles 6. Furthermore, the drive means 100 are arranged for controlling the potential difference of each picture element 2 to subsequently be a picture potential difference for enabling the particles 6 to occupy one of said positions for displaying the picture. The drive means 100 are further arranged for controlling for each picture element 2 of at least a number of the picture elements 2 the preset energies E of the preset potential differences in the sequence to depend on a serial number i in the sequence to obtain for each preset potential difference in the sequence a substantially equal magnitude of the change of the position of the particles 6. FIG. 3 shows three examples of such a relation between the preset energies E of the preset potential differences in the sequence and the serial number i. The relations are represented by the lines with label ‘a’, ‘b’ and ‘c’. The sequence of preset potential differences represents for each relation the same value of the total energy. The relation denoted by label ‘b’ is a substantially decreasing function which is locally substantially constant.

In an embodiment, the drive means 100 are further arranged for controlling for each picture element 2 of the number of the picture elements 2 the preset energies E of the preset potential differences in the sequence to be a decreasing function of the serial number i.

FIG. 3 shows two examples of such a function, represented by the lines with label ‘a’ and ‘c’. The function denoted by label ‘a’ is a decreasing function, whereas the function denoted by label ‘c’ is linearly decreasing.

In another embodiment, the drive means 100 are further arranged for controlling for each picture element 2 of the number of the picture elements 2 the preset values of the preset potential differences in the sequence to control the preset energies in the sequence. Then the preset durations in the sequence may be substantially constant. As an example the appearance of a picture element 2 is light gray, denoted by LG, before the application of the sequence of preset potential differences. Furthermore, the picture appearance of the picture element 2 for displaying the picture is dark gray, denoted by DG. For this example, the potential difference of the picture element 2 is shown as a function of time in FIG. 4A. In the example, the sequence of preset potential differences, present from time t1 to time t2, has 4 preset values, subsequently 20 Volts, −15 Volts, 10 Volts and −5 Volts. Each preset value is applied for e.g. 20 ms. As a result the preset energies of the preset potential differences in the sequence are a linearly decreasing function of the serial number.

The time interval between t2 and t3 is negligibly small. The picture potential difference is present from time t3 to time t4 and has e.g. a value of −15 Volts and a duration of 100 ms. As a result the picture element 2 has an appearance being dark gray, for displaying the picture. As another example, shown in FIG. 4B, the sequence of preset potential differences, present from time t1 to time t2, has 4 preset values, subsequently 20 Volts, −20 Volts, 10 Volts and −10 Volts. Each preset value is applied for e.g. 20 ms. As a result the preset energies of the preset potential differences in the sequence are a decreasing function of the serial number which is locally constant. This is also an example of an embodiment having the drive means 100 further arranged for controlling for each picture element 2 of at least the number of the picture elements 2 the sequence to have an even number of preset potential differences and the preset energy of each preset potential difference having an even serial number to be substantially equal to the preset energy of the respective preceding preset potential difference. As an advantage, the DC component of the sequence of preset potential differences of each picture element 2 of the number is substantially zero, then.

In another embodiment, the drive means 100 are further arranged for controlling for each picture element 2 of the number of the picture elements 2 the preset durations of the preset potential differences in the sequence to control the preset energies in the sequence. Then substantially constant absolute values of the preset values of the preset potential differences may be used in the sequence. As an example the appearance of a picture element 2 is light gray before the application of the sequence of preset potential differences. Furthermore, the picture appearance of the picture element 2 for displaying the picture is middle gray, denoted by MG. For this example, the potential difference of the picture element 2 is shown as a function of time in FIG. 5. In the example, the sequence of preset potential differences, present from time t1 to time t2, has 6 preset values, subsequently alternating in sign and having a magnitude of 15 Volts. The preset values are applied for e.g. 30 ms, 30 ms, 20 ms, 20 ms, 10 ms and 10 ms. Then, the preset energies of the preset potential differences in the sequence are a decreasing function which is locally constant of the serial number and the DC component of the sequence of preset potential differences is zero. The time interval between t2 and t3 is negligibly small. The picture potential difference is present from time t3 to time t4 and has e.g. a value of −15 Volts and a duration of 50 ms. As a result the picture element 2 has an appearance being middle gray, for displaying the picture.

It is favorable, if, in each aforementioned embodiment, each picture element 2 is one of the number of the picture elements 2.

It will be apparent that the picture potential differences are not limited to the described previous embodiments, as e.g. picture potential differences which are potential value modulated are also applicable.

1. An electrophoretic display panel (1), for displaying a picture, comprising:
an electrophoretic medium (5) comprising charged particles (6) in a fluid;
a plurality of picture elements (2);
a first and a second electrode (3,4) associated with each picture element (2) for receiving a potential difference; and
drive means (100),
the charged particles (6) being able to occupy extreme positions near the electrodes (3,4) and intermediate positions in between the electrodes (3,4),
the drive means (100) being arranged for controlling the potential difference of each picture element (2)
to be a sequence of preset potential differences having preset values and associated preset durations, the preset values in the sequence alternating in sign, each preset potential difference representing a preset energy sufficient to release particles (6) present in one of said extreme positions from their position but insufficient to enable said particles (6) to reach the other one of the extreme positions, each preset potential difference having as a result a change of the position of the particles (6), and subsequently
to be a picture potential difference for enabling the particles (6) to occupy one of said positions for displaying the picture, characterized in that
the drive means (100) are further arranged for controlling for each picture element (2) of at least a number of the picture elements (2) the preset energies of the preset potential differences in the sequence to depend on a serial number in the sequence to obtain for each preset potential difference in the sequence a substantially equal magnitude of the change of the position of the particles (6).

2. A display panel (1) as claimed in claim 1 characterized in that the drive means (100) are further arranged for controlling for each picture element (2) of at least the number of the picture elements (2) the preset energies of the preset potential differences in the sequence to be a decreasing function of the serial number.

3. A display panel (1) as claimed in claim 2 characterized in that the function is substantially linear.

4. A display panel (1) as claimed in claim 1 characterized in that the drive means (100) are further arranged for controlling for each picture element (2) of at least the number of the picture elements (2) the preset values of the preset potential differences in the sequence to control the preset energies in the sequence.

5. A display panel (1) as claimed in claim 1 characterized in that the drive means (100) are further arranged for controlling for each picture element (2) of at least the number of the picture elements (2) the preset durations of the preset potential differences in the sequence to control the preset energies in the sequence.

6. A display panel (1) as claimed in claim 1 characterized in that the drive means (100) are further arranged for controlling for each picture element (2) of at least the number of the picture elements (2) the sequence to have an even number of preset potential differences and the preset energy of each preset potential difference having an even serial number to be substantially equal to the preset energy of the respective preceding preset potential difference.

7. A display panel (1) as claimed in claim 1 characterized in that each picture element (2) is one of the number of the picture elements (2).
